(19) United States
(12) Patent Application Publication
(10) Pub. No.: US 2025/0023818 A1
(43) Pub. Date: Jan. 16, 2025

(54) Method for transmitting a data stream in a communication network, method for processing a data stream, method for controlling the processing of a data stream, and corresponding devices, terminal apparatus, execution entity, control entity, system and computer programs

(71) Applicant: ORANGE, ISSY LES MOULINEAUX (FR)

(72) Inventors: Nicolas Bihannic, CHÂTILLON CEDEX (FR); Pierre-Alexandre Masson, CHÂTILLON CEDEX (FR)

(21) Appl. No.: 18/714,816

(22) PCT Filed: Dec. 5, 2022
(86) PCT No.: PCT/EP2022/084438

§ 371 Date: May 30, 2024

(30) Foreign Application Priority Data
Dec. 8, 2021 (FR) FR2113160

(51) Int. Cl. H04L 45/42; H04L 45/00; H04L 47/24

(52) U.S. Cl. CPC H04L 45/42; H04L 45/566; H04L 47/24

(57) ABSTRACT

Transmitting a data stream received from a software application running on a terminal apparatus, in a communication network to which the terminal apparatus is connected, the network being divided into plural network slices. The method includes: selecting a network slice from the plurality at least according to an item of information contained in a header of the stream; obtaining a type of the stream, which belongs to a group including a first type and a second type of stream; inserting a priority indicator associated with the type of stream into the data stream, the priority indicator belonging to a group including at least one first indicator associated with the first type of stream and a second indicator associated with the second type of stream, the first and second priority indicators having different values; and transmitting the data stream containing the priority indicator in the selected network slice.

### 1. FIELD OF THE INVENTION

The invention lies in the field of telecommunications, and notably in that of communication networks structured in network slices.

In particular, the invention relates to the transmission, processing and control of the data streams routed in such a network slice.

It applies notably, but not exclusively, to a mobile telecommunication network, the architecture of which complies with the 3GPP (Third Generation Partnership Project) standard, in its 5G version or in a future version.

### 2. PRIOR ART AND ITS DISADVANTAGES

The digitisation of industrial processes contributes to diversifying the nature of the data passing through an operator's networks. For example, the Internet of Things (IoT) enables the implementation of new services such as predictive maintenance, with a view to improving operational efficiency. These new services are not necessarily real-time, but they are becoming increasingly important for customers.

For example, an “augmented technician” business application thanks to which a technician can visualise various data to enrich the context of an operation scene is known. It is for example a history of the operations carried out on a selected industrial part or a handling process for the selected industrial part. This technician can also benefit from voice assistance with a remote expert. A “digital twin” business application that enables operating information measured by connected sensors to be fed back to an information system of the customer in order to build a virtual representation of these sensors' execution environment is also known. This business application also enables a user located near these sensors to benefit from voice assistance with a remote expert in the event of a malfunction or if one or more of these sensors needs to be reconfigured. Each of these applications described by way of example generally involves data streams of different kinds, which are not necessarily real-time but are becoming increasingly important for both customers and service providers.

Apart from the IoT, other examples of non-real-time services are emerging, such as business application updates, entertainment and gaming applications for the consumer market, or mapping for the connected car sector.

Network slicing technology, introduced in particular in the 5G specifications, is promising for the implementation of specialised networks and the differentiated routing of application data, in particular to support IoT services which have varying requirements in terms of bit rate, availability or energy consumption. A network slice is a software-defined network whose operation is specially configured to meet the needs of a customer and/or a terminal and/or an application, and in particular to implement new services. This technology therefore makes it possible in particular to meet the specific needs of the operator's various customers by reserving one or more slices of their communication network for each of them. According to the 3GPP 5G standard, a network slice consists of physical and/or virtual network functions PNF/VNF that are interconnected and may belong to the access and/or core part of the communication network. The synthesis of a network slice thus serves a particular functional purpose and, once instantiated, is used to support certain communication services for a dedicated “vertical” customer (e.g. a company, a service offering, etc.) by providing a given quality of service guarantee. Each network slice may have its own architecture, its own FCAPS (for “Fault-management, Configuration, Accounting, Performance, and Security”) operations and its own security for a particular use case.

The state of the art in the specification of network slices makes it possible to select a network slice for a given customer application, according to a mechanism implemented via the URSP (for “User Equipment Route Selection Policies”) rules defined in the [3GPP TS 24.526] and [3GPP TS 23.503] specifications. A number of attributes can be used to route the data streams from a given customer application to the corresponding network slice:
the identifier of the application “Application ID”, the FQDN (Fully Qualified Domain Name), Ie triplet “IP address, port number, protocol ID”, the DNN (Data Network Name).

For example, as illustrated in [FIG. 1], an augmented technician application API_TA implements three data streams of different kinds, comprising:
a type of stream STR_1 of voice over IP or VoIP data;
a type of stream STR_2 of video streaming data;
a type of stream STR_3 of enriched data.

By way of another example, a digital twin application API_JN implements two streams of different kinds, comprising:
a type of stream STR_1′ of voice over IP or VoIP data;
a type of stream STR_2′ of sensor data.

However, the routing mechanism through the URSP rules is essentially static. It cannot be used to configure or control a routing priority dynamically between a data stream and another data stream from the same customer application whose data streams are routed in a specific network slice. However, it is understood that the customer would like to be able to associate different priorities dynamically with these different streams so that streams of the STR_1 type are processed with high priority and routed in real time, streams of the STR_2 type are routed with standard priority and data streams of the STR_3 type are routed with low priority.

A quality of service management policy based on a 5QI specification defined by 3GPP in the [3GPP TS 23.501-section 5.7.3.1] specification and that is applied to the data packets processed by a communication network which complies with the 3GPP standard is also known. According to this specification, the routing of data packets in a network slice must meet several criteria, among which:
a resource type criterion, which specifies whether the bit rate must be guaranteed,
a priority level criterion, which specifies the priority level of the packet,
a packet delay budget criterion, which specifies the authorised end-to-end transfer delay (including the radio and network core segments),
a packet error rate criterion, which specifies the error rate in the packet transmission,
an averaging window criterion, which specifies how long a packet is held in memory at a device of the network user plane,
a maximum data burst volume criterion, which characterises the nature of the data volume.

The data packet priority criterion of the indicator 5QI is configured to take on about twenty fixed values associated with standardised packet types, for example, a conversational voice packet or a conversational video packet.

A disadvantage of this mechanism for prioritising data packets in a network slice is that it does not allow adaptation to the specific needs of a customer who would like to define dynamically their own priority levels for their own types of data streams according to the intended application and possibly to change their respective priority levels according to the actual situation (nominal or alarm, for example).

The invention improves the situation.

### 3. DISCLOSURE OF THE INVENTION

The invention responds to this need by proposing a method for transmitting a data stream received from a software application running on a terminal apparatus, in a communication network to which said terminal apparatus is connected, said network being divided into a plurality of network slices, characterised in that said method is implemented at said terminal apparatus and comprises
selecting one network slice from said plurality at least according to an item of information comprised in a header of the data stream,
obtaining a type of said stream, said type belonging to a group comprising at least one first type and one second type of stream,
inserting a priority indicator associated with the type of stream into the data stream, the priority indicator belonging to a group comprising at least one first indicator associated with the first type of stream and one second indicator associated with the second type of stream, the first priority indicator and the second priority indicator having different values; and
transmitting the data stream comprising the priority indicator in the selected network slice.

The invention is based on a completely new and inventive approach which consists in inserting a priority indicator into a data stream transmitted by an application of a customer eligible to be routed via a given network slice. This priority indicator is inserted, for example, into a header or into the useful part (i.e. payload part) of the data stream. It is intended to be detected by one or more network entities in charge of processing the routing of the data stream in the network slice and to be used to decide how to process the data stream according to the available network resources and in particular whether or not it can be routed by the selected network slice. With the invention, it is thus possible to prioritise the data streams transmitted by a software application running on the terminal apparatus in a particular network slice. This network slice may or may not be dedicated to the software application. In case it is a software application of a customer, the network slice may be dedicated to this application or to several applications of this customer, or even to all the streams transmitted by this customer in general. The invention then enables the customer to assign the desired priority level to each of the types of application streams implemented in their software application(s). A software application refers here to a business application associated, for example, with a customer, this business application comprising different streams (voice, data, streaming, management, etc.) requiring different priorities according to their needs.

If the software application is configured to implement a specific service of an operator, such as the “Voice over IP” service, the network slice in question may be reserved for routing the Voice over IP application streams transmitted by this software application, regardless of the terminal apparatus or the customer using this terminal apparatus. In this case, the operator advantageously configures different types of Voice over IP streams, for example according to a quality of service level to which each customer has access in connection with the subscription they took out. In this case, the software application is an application, for example of the VoIP type, and the priorities are associated, for example, with customers who have different contracts and therefore different priorities for the voice over IP software application. Various parameters in the header of the data stream can thus be used separately or in combination, among which an identifier of the software application, such as the identifier of the protocol used (for example, the RTP—Real Time Protocol—protocol), the IP address of the transmitter or even the IP address of the recipient.

Finally, the network slice can be configured by the operator to group together the data streams transmitted by the software applications of several distinct customers, which have, for example, common requirements in terms of availability or data stream isolation, etc. In this case, the operator can define several types of data streams and associated priority indicator values in a common manner for all the customers sharing the network slice.

Another advantage of the invention is that it can select the network slice to be used for a data stream at the terminal apparatus, rather than at a device of the communication network itself. The load is thus transferred from the network to the terminal. Moreover, because the terminal apparatus only has to manage its own data streams, this selection is easier to implement and better meets scalability constraints. Indeed, thanks to the implementation of network slices on terminals, it is possible to associate data streams of the terminal with distinct slices, which is more difficult to implement when the network slice is instantiated on a device of the operator network where the streams are more numerous and moreover potentially encrypted, making it impossible to use header data. Moreover, the customer owning the terminal can manage the slices themselves, whereas they will not be able to do so with an instantiation on a network device, as may be the case when implementing a Virtual Private Network (VPN), the network slice architecture also offering greater stream isolation capabilities than virtual private networks in particular.

According to one aspect of the invention, the method further comprises:
previously receiving at least one rule for routing a data stream transmitted by said software application, said rule comprising at least one identifier of said software application, said type of stream, said priority indicator associated with said type of stream and an identifier of a said network slice;
storing in memory said at least one routing rule and
applying said at least one routing rule when implementing said selection and said insertion.

Advantageously, this prioritisation of the data streams transmitted by the software application is implemented by previously installing rules defining the value of the priority indicator to be inserted into the data stream in addition to the network slice to be used.

For example, in a 5G architecture, the network slice is identified by an S-NSSAI parameter. It should be noted that the 5G mobile access network keeps a context of the network slices for which the terminal has previously registered and that it is not necessary to insert this information field into a header of the data stream.

If the software application is an application of a customer, the customer can define their own types of streams and the priority indicator values they associate with each of them. If the software application implements a service of the operator, such as a voice over IP service, then the operator defines the types of data streams, for example by customer or subscription level type, and associates a priority indicator value with them.

According to another aspect of the invention, the method further comprises obtaining an operating mode of said software application, said operating mode belonging to a group comprising at least one first operating mode and a second operating mode, and said at least one routing rule is associated with said operating mode.

One advantage is that the rules for prioritising the data streams with respect to each other can be modified according to a current operating mode of the application.

For example, when the software application is that of a customer, these operating modes are previously defined by the customer and comprise at least one first, “nominal”, mode and a second, “alarm”, mode, and specific rules for processing the data streams are associated with each of these modes. They can further comprise a third mode of the “Prioritised Reporting” type which, unlike the alarm mode, can be scheduled or even recurrent over a given time slot. Such an operating mode can be advantageously implemented in all industries for operational performance monitoring.

For example, for a “digital twin” application, a data stream of the “sensor data” is associated with a minimum to average value of the priority indicator in “nominal” operating mode, but with a maximum value of the priority indicator in “alarm” operating mode. Indeed, this sensor data is useful for managing a crisis and must be received in real time with maximum priority in “alarm” mode.

It is therefore understood that a current operating mode, for example corresponding to a nominal situation, can be defined beforehand at the user terminal that will apply the routing rules associated with this operating mode, but that it can be modified over time by notification from a customer entity connected to the network. Upon receipt of a notification for an operating mode change, for example, switching to an alarm-type operating mode, the user terminal will apply the routing rules associated with this new operating mode for future data streams transmitted by the software application in the network slice.

The invention also relates to a device for transmitting a data stream by a software application running on a terminal apparatus, in a communication network to which said terminal is connected, said network being divided into a plurality of network slices. Said device is configured to implement at the terminal apparatus:
selecting one network slice from said plurality at least according to an item of information comprised in a header of the data stream;
obtaining a type of said stream, said type belonging to a group comprising at least one first type and one second type of stream,
inserting a priority indicator associated with the type of stream into the data stream, the priority indicator belonging to a group comprising at least one first indicator associated with the first type of stream and a second indicator associated with the second type of stream, the first priority indicator and the second priority indicator having different values; and
transmitting the data stream comprising said priority indicator in the selected network slice.

Advantageously, said device is configured to implement the steps of the transmission method as described above.

Advantageously, said device is integrated into a terminal apparatus connected to the communication network, such as a user terminal or a connected object.

Advantageously, said terminal apparatus is comprised in a system for controlling data streams routed in a communication network.

The system, the terminal apparatus and the transmission device have at least the same advantages as those conferred by the above-mentioned transmission method.

Correlatively, the invention also relates to a method for processing a data stream in a communication network, said network being divided into a plurality of network slices, said data stream having been received in a said network slice of said plurality from a software application running on a terminal apparatus connected to said network. Said method is implemented by an execution entity of the network and comprises:
detecting a priority indicator of said stream in a said data stream;
evaluating a level of resources available in the network slice;
executing at least one action for processing said data stream at least according to said priority indicator and the level of network resources available in said network slice, said processing action belonging to a group comprising at least one first action to let the data stream pass in said network slice, when the level of available resources is sufficient for routing the data stream according to the priority indicator, and a second action to block the data stream in said network slice, intended to be implemented when the level of available network resources is insufficient.

The invention is based on a completely new and inventive approach to processing a data stream received from a customer application by an execution entity of the communication network, which consists in detecting a priority indicator of the stream in a header of this stream and using it to decide, according to a level of available resources compared with a level of resources required for routing the data stream with the priority level associated with it, whether this stream can be routed in the network slice to its destination or whether it must be rejected.

Of course, the invention is not limited to the two pass and block actions just described. Other actions may be decided upon, in particular when the level of resources is evaluated as insufficient for routing the data stream under the conditions associated with the priority level. For example, other possible actions would be to defer the routing of the data stream to let other data streams with a higher priority pass, to clip the stream before transmitting it so that it requires fewer resources, to slow down or speed up the routing of the data stream by assigning fewer or more resources to it according to its priority level, etc.

According to one aspect of the invention, the method comprises previously obtaining at least one rule for processing a data stream received from said software application, said rule comprising said priority indicator of a data stream, said network slice identifier and said at least one action for processing said stream, and extracting the processing action from said rule.

To decide on the action to be executed, the node device applies processing rules it has previously received and stored. One advantage is that it can process the incoming data stream without delay. This embodiment is suitable for the implementation of simple rules.

According to another aspect of the invention, when no processing rule has been previously obtained for processing said data stream, said method further comprises notifying said priority indicator to a control entity of said network and receiving, from said control entity, said at least one processing action to be executed.

According to at least one other embodiment of the invention, the execution entity does not have at its level rules for processing the data streams it receives from the customer application. The basic rule it applies is to notify a control entity, which responds with the processing action(s) to be executed on a case-by-case basis. This embodiment is suitable for the implementation of more complex rules. The intelligence of the network is concentrated at the control entity or entities.

According to yet another aspect of the invention, the execution entity being configured to manage the network slice and at least one other network slice of said communication network, when the processing action is the second action to block the data stream in the network slice, the method comprises, prior to executing the second processing action:
evaluating a level of resources the other network slice;
deciding on at least one third processing action, referred to as the action to transfer the data stream to the other network slice, according to said level of resources and the priority indicator.

One advantage is to give some data streams, for example the highest priority ones, an additional opportunity to be routed in the communication network, when the network slice in which they are is short of resources and when there is another network slice with a sufficient level of available resources for routing the data stream under the conditions corresponding to its associated priority level.

The invention also relates to a device for processing a data stream in a communication network, said network being divided into a plurality of network slices, said data stream having been received in a said network slice of said plurality, from a software application running on a terminal apparatus (UE, IoT) connected to said network. Said device is configured to implement at an execution entity of the network:
detecting a priority indicator of said stream in said data stream;
evaluating a level of resources available in the network slice;
executing at least one action for processing said data stream at least according to said priority indicator and the level of network resources available in said network slice, said processing action belonging to a group comprising at least one first action to let the data stream pass in said network slice, when the level of available resources is sufficient, and a second action to block the data stream in said network slice, intended to be implemented when the level of available network resources is insufficient.

Advantageously, said device is configured to implement the steps of the processing method as described above.

Advantageously, said device is integrated into an execution entity of the communication network, comprised for example in the user plane of this network.

Advantageously, said execution entity is comprised in the system for controlling data streams routed in a communication network.

The system, the execution entity and the processing device have at least the same advantages as those conferred by the above-mentioned processing method.

Correlatively, the invention also relates to a method for controlling the processing of a data stream in a communication network, said communication network being divided into a plurality of network slices, said data stream having been transmitted by a terminal apparatus and received by an execution entity of said network in a network slice of said plurality. Said method is implemented by a control entity of said network, said control entity being configured to control the implementation of a policy for processing the data streams routed in said network and said method comprises:
receiving from the execution entity a notification of a priority indicator associated with said received data stream;
obtaining a level of resources available in the network slice;
deciding on at least one action for processing said stream at least according to the received priority indicator and the level of available resources, said processing action belonging to a group comprising at least one first action to let the data stream pass in said network slice intended to be implemented when the level of available network resources is sufficient and a second action to block the data stream in said network slice intended to be implemented when the level of available network resources is insufficient; and
sending a response to said execution entity, said response comprising said processing action.

According to one embodiment of the invention, the control entity applies itself the rules for processing the data streams received from the software application of the customer by the execution entity, upon notification from the execution entity, and sends the processing action to be executed to this execution entity. In this way, it controls the processing of all the data streams transmitted by the customer application in the network slice, and decision intelligence is focused on the control plane.

According to one aspect of the invention, when the processing action decided upon is the action to block said data stream in the network slice and when the execution entity is configured to manage another network slice of said plurality, said method comprises, prior to transmitting the second processing action to the execution entity:
obtaining a level of resources available in the other network slice;
deciding on at least one third processing action, referred to as the action to transfer the data stream to the other network slice, according to said level of resources and the priority indicator.

Advantageously, a fallback mode is implemented for the highest priority data streams that could not be routed in the initially planned network slice. If another network slice to which the customer is eligible has sufficient network resources for routing the data stream under the conditions of its priority level, then the control entity may decide to transfer the data stream to another network slice to which the customer application is eligible.

The invention also relates to a device for controlling the processing of a data stream in a communication network, said communication network being divided into a plurality of network slices, said data stream having been transmitted by a terminal apparatus and received by an execution entity of said network in a network slice of said plurality. Said device is configured to implement at a control entity of said network, said control entity being configured to control the implementation of a policy for processing the data streams routed in said network:
receiving from the execution entity a notification of a priority indicator associated with said received data stream;
obtaining a level of resources available in the network slice;
deciding on at least one action for processing said stream at least according to the received priority indicator and the level of available resources, said processing action belonging to a group comprising at least one first action to let the data stream pass in said network slice intended to be implemented when the level of available network resources is sufficient for routing said data stream according to the priority indicator and a second action to block the data stream in said network slice intended to be implemented when the level of available network resources is insufficient; and
sending a response to said execution entity, said response comprising said processing action.

Advantageously, said device is configured to implement the steps of the control method as described above.

Advantageously, said device is integrated into a control entity of the communication network, comprised for example in the control plane of this network.

Advantageously, said control entity is comprised in the system for controlling data streams routed in a communication network.

The system, the control entity and the control device have at least the same advantages as those conferred by the above-mentioned control method.

Alternatively, the invention finally relates to a system for controlling data streams routed in a communication network comprising the above-mentioned transmission device, the above-mentioned processing device and the above-mentioned control device.

Advantageously, the control system according to the invention also comprises a rule management entity, configured to define rules for routing, processing and controlling the data streams transmitted by a software application in a network slice, and to transmit them to the transmission, processing and control devices according to the invention.

The invention also relates to computer program products comprising program code instructions for respectively implementing transmission, processing and control methods as described previously, when it is executed by a processor.

A program can use any programming language, and can be in the form of source code, object code, or intermediate code between source code and object code, such as in a partially compiled form, or in any other desirable form.

The invention also relates to at least one computer-readable storage medium on which is saved a computer program comprising program code instructions for implementing the steps of the methods according to the invention as described above.

Such a storage medium can be any entity or device able to store the program. For example, the medium can comprise a storage means, such as a ROM, for example a CD-ROM or a microelectronic circuit ROM, or a magnetic recording means, for example a mobile medium (memory card) or a hard disk or SSD.

On the other hand, such a storage medium can be a transmissible medium such as an electrical or optical signal, that can be carried via an electrical or optical cable, by radio or by other means, so that the computer program contained therein can be executed remotely. The programs according to the invention can be downloaded in particular on a network, for example the Internet network.

Alternatively, the storage medium or media can be one or more integrated circuits in which the program is embedded, the circuit(s) being adapted to execute or to be used in the execution of the above-mentioned method(s).

According to one embodiment, the present technique is implemented using software and/or hardware components. In this context, the term “module” may be used in this document to refer to a software component, a hardware component or a combination of hardware and software components.

A software component is one or more computer programs, one or more subroutines of a program, or more generally any element of a program or software capable of implementing a function or set of functions, as described below for the module concerned. Such a software component is executed by a data processor of a physical entity (terminal, server, gateway, set-top-box, router, etc.) and is able to access the hardware resources of this physical entity (memories, recording media, communication buses, electronic input/output cards, user interfaces, etc.). Hereafter, resources are understood to be any set of hardware and/or software elements that support a function or a service, whether individually or in combination.

In the same way, a hardware component is any element of a hardware assembly capable of implementing a function or set of functions, as described below for the module concerned. It may be a programmable hardware component or a component with an embedded processor for executing software, for example, an integrated circuit, a smart card, a memory card, an electronic card for executing firmware, etc.

Each component of the system described above naturally implements its own software modules.

The various embodiments mentioned above can be combined with each other for the implementation of the present technique.

### 4. BRIEF DESCRIPTION OF THE FIGURES

Other purposes, features and advantages of the invention will become more apparent upon reading the following description, hereby given to serve as an illustrative and non-restrictive example, in relation to the figures, among which:

FIG. 1 diagrammatically illustrates examples of types of data streams implemented in customer applications and intended to be routed in a slice of a communication network;

FIG. 2 diagrammatically illustrates an example of the architecture of a system for controlling data streams transmitted in a communication network according to one embodiment of the invention;

FIG. 3 describes in the form of a flowchart the steps of a method for transmitting a data stream in a slice of a communication network according to one embodiment of the invention;

FIG. 4 describes in the form of a flowchart the steps of a method for processing a data stream transmitted in a slice of a communication network according to one embodiment of the invention;

FIG. 4A details the obtaining of an action for processing the data stream according to a first embodiment of the invention;

FIG. 4B details the obtaining of an action for processing the data stream according to a second embodiment of the invention;

FIG. 5 describes in the form of a flowchart the steps of a method for controlling the processing of a data stream transmitted in a slice of a communication network according to one embodiment of the invention;

FIG. 6 diagrammatically illustrates the processing of a data stream transmitted in a network slice by an execution entity of the user plane of a communication network according to one embodiment of the invention;

FIG. 7 diagrammatically illustrates an example of the architecture of a communication network, comprising a plurality of execution entities configured to process the routing of a data stream transmitted by a terminal apparatus in at least one slice of the communication network, a plurality of control entities configured to control the processing of this stream by the execution entities and a plurality of management entities configured to send processing and control rules to these pluralities of entities according to one embodiment of the invention;

FIG. 8 describes an example of a hardware structure of a device for transmitting a data stream in a slice of a communication network according to the invention;

FIG. 9 describes an example of a hardware structure of a device for processing a data stream transmitted in a slice of a communication network according to the invention;

FIG. 10 describes an example of a hardware structure of a device for controlling the processing of a data stream in a slice of a communication network according to the invention.

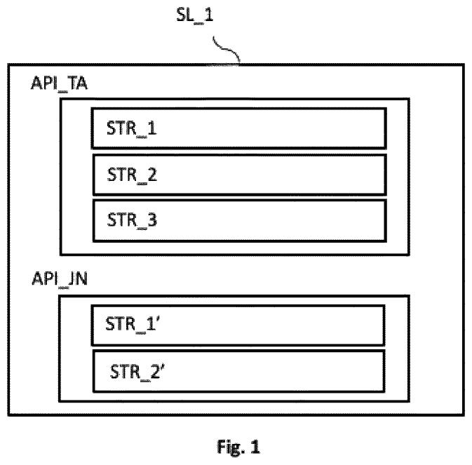

### 5. DETAILED DESCRIPTION OF THE INVENTION

The invention relates to a communication network structured in a plurality of network slices. The general principle of the invention is based on the insertion of a priority indicator into a data stream transmitted by a software application running on a terminal apparatus connected to the communication network, before it is transmitted in the communication network of this operator, and on the use of this indicator to process the routing of this data stream in a particular network slice of the communication network. This network slice may be dedicated to this customer to enable them to route the data streams generated by one or more of their own software applications, or business applications, or on the contrary shared between several customers of the operator to route the data streams originating from different software applications of these customers, or yet dedicated to the implementation of a particular service of the operator, such as a voice over IP service.

In the communication network, the priority indicator is detected by an execution entity of a user plane of the operator's network and used to decide, according to a level of resources available in the network slice at this execution entity and to the resource requirements corresponding to this priority level, whether or not the data stream can be routed in this network slice.

Advantageously, the value of the priority indicator associated with each type of data stream transmitted by the software application is defined beforehand depending on the needs of the software application. In particular, in the case of a customer's business application, the customer defines their own types of streams and their associated priority level. The value of the priority indicator may change over time, particularly following a change in the software application's operating mode.

The invention thus makes it possible to adapt network slice technology more finely to the increased needs of customers and to the diversity of the data streams relating to one or more of these customers.

In the case where the software application in question implements a service of the operator, the invention enables the operator to apply their differentiated quality of service policy within a network slice.

The invention also enables the operator to group together within the same network slice the applications of different customers who share common requirements and to apply to them the same strategy for allocating the resources of the network slice. These include requirements in terms of availability of the data streams transmitted by the applications (real time, non-real time) or in terms of isolation, that is the level of protection against disturbances such as congestion or potential attacks on the communication network.

The invention has a particular application in a mobile communication network whose architecture complies with the 3GPP 5G standard and allows this network to be structured in slices. Of course, the invention is not limited to this example and extends to any other communication network architecture implementing a technology enabling, like the URSP rules for 3GPP terminal apparatuses, the discrimination of the data streams originating from a software application.

In the following, this notion of priority indicator refers to a value, for example an integer value, comprised within a range of possible values. Advantageously, this interval comprises a small number of values, for example equal to the number of distinct types of data streams for the software application(s) associated with the network slice in question.

In the following, a network resource of a network slice refers to both hardware resources and software resources at the core network and an access network, for example a mobile Radio Access Network (RAN) of the communication network.

This notion of resource encompasses the access device or the node device itself, other resources of this device, such as a data modulation module, a module for allocating time slots for data transmission, a module for managing the quality of service associated with the various types of data transmitted (voice, IoT (Internet of Things), video, etc.). For a base station of a cellular access network, for example, these are specific components of this radio antenna, such as Physical Resource Blocks (PRBs), modulation modules, modules for allocating time slots for data transmission, modules for managing the Quality of Service (QOS) for the various types of data transmitted, etc. The availability of these resources is evaluated based on data traffic information relating to a bandwidth, a data bit rate, a data volume, a number of physical resource blocks or PRBs, etc., already allocated or, on the contrary, available, at a mobile access device such as a base station or a node device of a user plane of the network core.

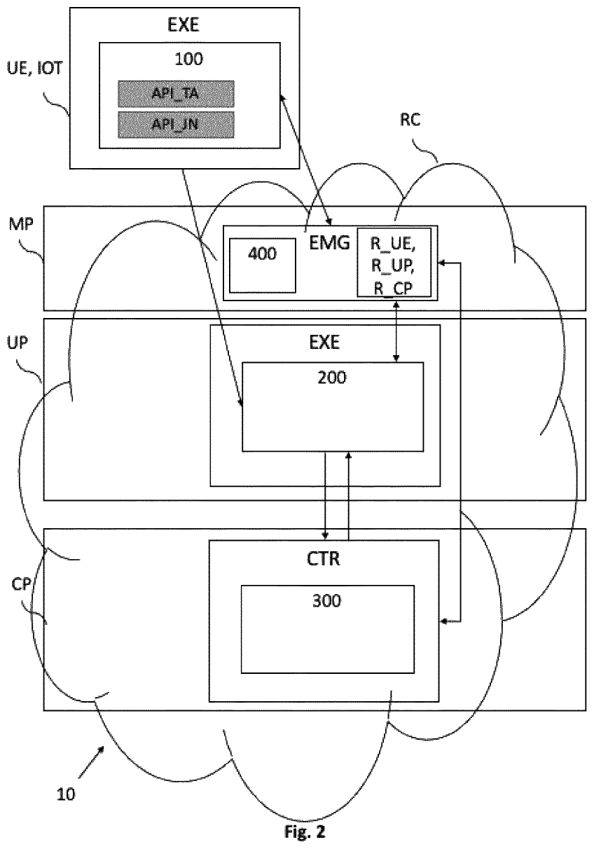

FIG. 2 diagrammatically illustrates an example of the architecture of a system S for controlling a data stream transmitted by a software application running on a terminal apparatus in an operator's communication network RC, divided into a plurality of network slices, according to one embodiment of the invention.

A terminal apparatus refers here both to a user terminal, such as a mobile phone of the smartphone type, a laptop, a tablet, a connected watch, etc., and a connected object of the IoT type, such as a sensor for measuring temperature or vibration data, etc., or an autonomous robot such as an Automated Guided Vehicle (AGV), for example installed in an industrial environment.

It is assumed that the terminal apparatus UE, or IoT, is connected to the network RC by an access network, such as a mobile radio access network via a radio access device. Of course, as already mentioned, the invention is applicable to other access technologies, whether wireless or wired. Consequently, the terminal apparatus may be in a non-restrictive manner connected to the network RC via a base station, a femto cell associated with this base station, a Digital Subscriber Line Access Multiplexer (DSLAM) device for an ADSL-type access network, a Wi-Fi hotspot or a Wi-Fi repeater associated with this hotspot, an Optical Network Termination (ONT) device for a Passive Optical Network (PON) fibre access network, etc.

According to this embodiment of the invention, the system S comprises this terminal apparatus, which comprises a device 100 for transmitting a data stream in the network RC, configured to select one network slice from said plurality of slices at least according to an item of information comprised in a header of the data stream, obtain an item of information relating to a type of said stream, said type belonging to a group comprising at least one first type and a second type of stream, insert a priority indicator associated with the type of stream into said data stream, the priority indicator belonging to a group comprising at least one first indicator associated with the first type of stream and a second indicator associated with the second type of stream, the first priority indicator and the second priority indicator having different values and transmit the data stream in the selected network slice. In this respect, it should be noted that in the case of a 5G architecture, the network core configures the terminal apparatus UE with all the network slices to which it is authorised to connect. Each of these slices is identified by an S-NSSAI (Single-Network Slice Selection Assistance Information) identifier.

Advantageously, the device 100 is configured to receive at least one rule for routing a data stream for said software application, said rule comprising at least an identifier of said software application, said type of stream, said priority indicator associated with said type and one identifier of a said network slice, store said at least one routing rule in memory and apply it when implementing said selection of said insertion. For example, this rule R_UE is stored in a memory of the device 100 or the terminal apparatus UE, IoT.

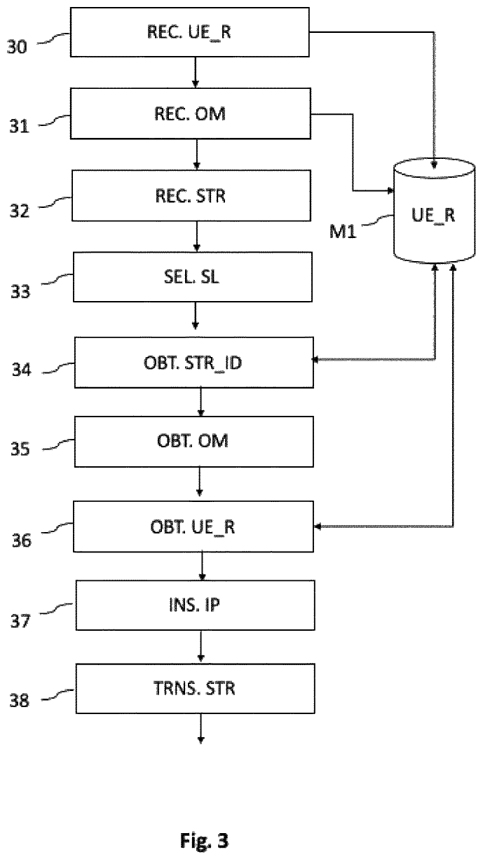

The device 100 thus implements the method for transmitting a data stream according to the invention that will be detailed hereafter in relation to [FIG. 3].

According to this embodiment of the invention, the system S also comprises an execution entity EXE of the communication network configured to manage the routing of data streams transmitted by terminal apparatuses in at least one slice of the communication network RC. Such an execution entity belongs to a user plane of the communication network RC according to the terminology defined in the ETSI TS 123 501 standard, published in September 2018. This is either an access device or a node device of the core network. The execution entity EXE can be instantiated in the form of a physical device dedicated or not to the respective functions of the execution entity EXE, or in the form of virtualised entities, such as virtual functions.

According to the invention, this execution entity comprises a device 200 for processing a data stream transmitted by a software application of a terminal apparatus UE, IoT in a said network slice. This device 200 is configured to obtain a level of available resources for routing the data stream in the network slice, detect a priority indicator of said stream in said data stream, and execute at least one action for processing said data stream at least according to said priority indicator and a level of network resources available in said network slice, said processing action belonging to a group comprising at least one first action to block the data stream in said network slice, intended to be implemented when the level of available network resources is insufficient, and a second action to let the data stream pass in said network slice, when the level of available network resources is sufficient.

Advantageously, the device 200 is configured to obtain at least one rule for processing R_UP a data stream received from said software application, said rule comprising said priority indicator of a data stream, said network slice identifier and said at least one action for processing said stream, storing it in memory and applying it to the data stream processing. This rule R_UP is advantageously stored in a memory of the device 200 or of the execution entity EXE.

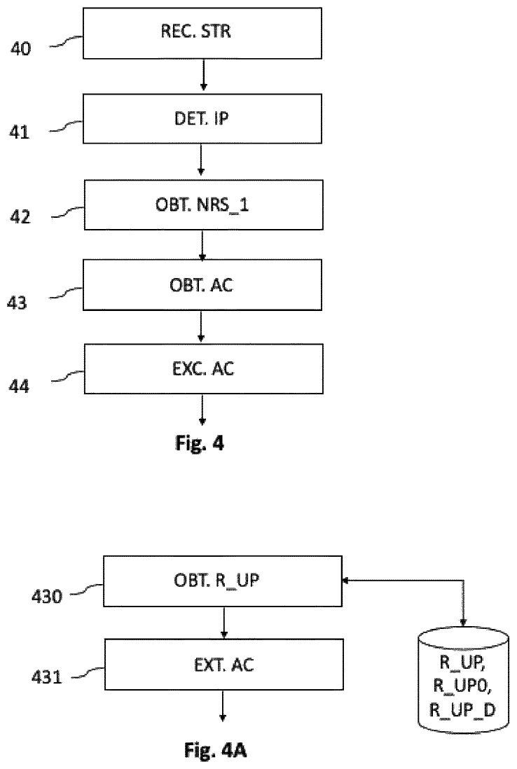

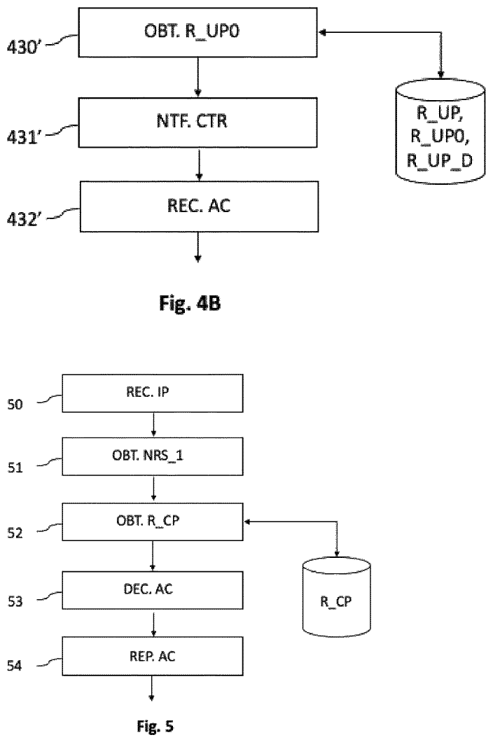

The device 200 thus implements the method for processing a data stream according to the invention that will be detailed hereafter in relation to [FIG. 4].

The system S also comprises a control entity CTR of the communication network RC, configured to control the implementation of a policy for processing data streams routed in said network by one or more execution entities. Such an entity is part of a control plane. It can be part of the access network or the core network. For example, in a radio access network, this is an Element Network Manager (ENM) which is part of a Network Management System (NMS) associated with 5G/4G base stations, also known as gNodeB or eNodeB respectively. For example, in a core network, this control entity could be the Session Management Function (SMF), which controls the User Plane Function (UPF) via the N4 interface in accordance with the 3GPP TS 23.501 specification. The control entity CTR can be instantiated in the form of a physical device dedicated or not to the respective functions of the controller CTR, or in the form of virtualised entities.

According to the invention, it comprises a device 300 for controlling the processing by the execution entity EXE of a data stream transmitted by a software application of the terminal apparatus UE, IoT in a slice of the communication network. Said device is configured to receive, from the execution entity, a notification of a priority indicator associated with said received data stream, to obtain a level of available resources for routing the data stream in the network slice, to decide on at least one action for processing said stream to be executed, at least according to the received priority indicator and a policy for processing the data streams transmitted by the software application, said processing action belonging to a group comprising at least one first action to block the data stream in said network slice intended to be implemented when the level of available network resources is insufficient and a second action to let the data stream pass in said network slice intended to be implemented when the level of available network resources is sufficient, and send a response to said execution entity, comprising said at least one processing action.

Advantageously, the device 300 is configured to obtain at least one rule for controlling R_CP a data stream received from said software application, said rule comprising said priority indicator of a data stream, said network slice identifier and said at least one action for processing said stream, store it in memory and apply it to the data stream processing control. This rule R_CP is advantageously stored in a memory of the device 300 or of the control entity CTR.

The device 300 thus implements the method for controlling the processing of a data stream according to the invention that will be detailed hereafter in relation to [FIG. 5].

Advantageously, the system S also comprises a management entity EMG for the plurality of slices of the communication network RC. It is part of a management plane of the communication network RC. In the context of a network slice architecture, such an entity implements the network slice management functions as described in the ETSI GR NFV-EVE 012 document relating to network slice support in a virtualised environment, published in December 2017. The management entity EMG can also be instantiated in the form of a physical device dedicated or not to the respective functions of the management entity, or in the form of virtualised entities.

According to the invention, this management entity comprises a rule management device 400, configured to obtain business information from a customer of a software application intended to be executed by a terminal apparatus, said information comprising at least types of data streams intended to be transmitted by the software application and priority indicators associated with each of the types of streams, transmit the rules to the terminal apparatus, the execution entity EXE and the control entity CTR respectively.

In the following, embodiments of the invention in a mobile telecommunication network, the architecture of which complies with the 5G version or a future version of the 3GPP standard and implements the division of the network into network slices, are described in more detail. Of course, as already mentioned, the invention is not limited to the examples described and also applies to other types of fixed or mobile telecommunication networks and to other wireless or wired access technologies.

In relation to [FIG. 3], an embodiment of a method for transmitting a data stream received from a software application API_TA, API_JM running on the terminal apparatus UE, IoT in the communication network RC according to the invention is now presented in the form of a flowchart. Advantageously, the method is implemented by the device 100 integrated into the terminal apparatus UE, IoT.

In the following, it is assumed that the communication network RC is divided into several slices SL_1 to SL_N, with N greater than 2. The case where the slices SL_1 and SL_2 are dedicated to the uses of a given customer, who implements in particular the software applications API_TM and API_JM, is more specifically described. These software applications are specific business applications of the customer, who has defined the various types of data streams implemented and their associated priority levels.

Of course, as already mentioned, the invention is not limited to this use case, but applies to any other strategy for assigning slices of an operator's communication network to customers, terminals, software applications, services, etc. In particular, according to at least one other embodiment of the invention, the operator defines a network slice dedicated to the routing the data streams transmitted as part of one of the services they offer to their customers, such as the Voice over IP service, for example. In this case, they define various types of Voice over IP data streams associated with various quality of service levels, relating to various subscription levels taken out by the customers (for example, gold, silver or bronze) and associates them with different priority indicator values, the “gold” Voice over IP data stream type having the highest priority and the “bronze” Voice over IP data stream type having the lowest priority.

In a preliminary phase, rules R_UE for routing data streams originating from this software application API_TA, API_JM are received in 30, for example originating from the management entity EMG. These rules associate a priority indicator with each data stream transmitted by the software application API_TA, API_JM.

Typically, such a rule comprises an identifier of the software application API_TA, API_JM, an identifier of the type of data stream STR_ID, an identifier of the network slice to be used to transmit the data stream in the communication network RC and the associated priority indicator IP value. For example, for the “Augmented Technician” business application, a data stream of type STR_1, the network slice SL_1, the structure of such a rule is as follows: “Priority Indicator IP-Business software application API_TA-Network slice SL_1-Data stream type STR_1”. They are stored in a memory, for example a memory M1 of the device 100 or a memory of the terminal apparatus UE, IoT.

Optionally, the rules UE_R received in 30 are associated with an operating mode of the software application API_TA, AP_JM. For example, there are three distinct operating modes:
a nominal operating mode MO_1, which corresponds to a normal operating situation;
an alarm operating mode MO_2, which corresponds to an alarm situation; and
a post-alarm operating mode MO_3, which corresponds to a return to normal or restart situation following the alarm.

Distinguishing between various operating modes makes it possible to modify the respective priority levels of each of the types of data streams used by a software application according to the situation in each of these modes.

For example, the indicator can take at least the following values:
IP_1, for example equal to 1 for a high priority real-time stream;
IP_2, for example equal to 2, for a high priority non-real-time or delayed stream;
IP_3, for example equal to 3, for a low priority non-real-time or delayed stream.

An example of assignment of priority levels to the “augmented technician” and “digital twin” business application streams for the three previously defined operating modes is presented below in Table 1.

TABLE 1

| | Priority indicator values by type of stream and operating | | | |
|---|---|---|---|---|
| | mode | | | |
| | | “Nominal” | “Nominal” | “Nominal” |
| Business | Type of | operating | operating | operating |
| application | stream | mode | mode | mode |
| “Augmented | Voice over IP | IP_1 | IP_1 | IP_1 |
| technician” | (STR_1) | | | |
| | Video | IP_2 | IP_1 | IP_2 |
| | streaming | | | |
| | (STR_2) | | | |
| | Enriched | IP_3 | IP_1 | IP_3 |
| | Data (STR_3) | | | |
| “Digital twin” | Voice over IP | IP_1 | IP_1 | IP_1 |
| | (STR_1′) | | | |
| | Sensor | IP_3 | IP_1 | IP_3 |
| | data (STR_2′) | | | |

In this case, the rules UE_R may, for example, comprise an additional attribute corresponding to their associated operating mode.

In 31, an item of information relating to a current operating mode of the software application API_TA, API_JM is received. It is assumed here that this is the nominal operating mode MO_1.

In an operating phase, a data stream STR is received in 32 from the software application API_TA, API_JM. In 33, the network slice is selected from at least one item of information comprised in a header of the data stream. It is for example the destination IP address that identifies the device that will receive this data stream, and/or an identifier of the application API_TA, API_JM. For example, this item of information is extracted from a header of a signalling protocol, such as the Non Access Stratum (NAS) protocol implemented in exchanges between the terminal apparatus and the 5G core network, and defined by the 3GPP TS 23.502 “4.16.12.2 UE Policy Association Modification initiated by the PCF” procedure.

In 34, the type of data stream STR_ID (for example, voice, video streaming or data exchange) is obtained, for example from the 2-uplet “(destination) IP address; protocol ID” extracted from a header of the stream or from the triplet of attributes “(destination) IP address, port number, protocol ID”. The triplet of attributes can be used, for example, to differentiate more finely between two distinct streams from the same application based on their distinct port numbers.

This is particularly the case when this application is configured to transmit these streams to the same application server, which is a primary one, but the latter transmits each of them to distinct specialised servers, which are secondary ones. For example, for the “augmented technician” application API_TA, a server specialised in pattern recognition receives the video streaming streams, another server specialised in indexing technical documentation receives the streams of enriched data and yet another server specialising in inter-personal connection services receives the voice over IP streams.

In 35, the value of the current operating mode MO_1 is obtained, if applicable. In 36, the rule UE_R stored in memory corresponding to the software application API_TA, API_JM which transmitted the stream STR to the type of data stream STR_ID and possibly to the current operating mode MO_1 is retrieved, making it possible to obtain the priority indicator IP value associated with this data stream STR. In 37, the priority indicator IP is inserted into the data stream STR. For example, it is inserted into a header of the data stream STR, such as a header of the application protocol used by the software application API_TA, API_JM. For example, the priority indicator IP is inserted into a variable of a header of an HTTP GET request. It can also be inserted into a header of an IP packet, an Ethernet frame or a 3GPP network context (PDP context, EPB bearer, PDU session). As a variant, it can also be inserted into the useful part (i.e. payload part) of such a packet, frame or context of the data stream STR.

In 38, the data stream STR thus modified is transmitted in the data slice SL_1 of the communication network RC.

It is understood that, following a change in the operating mode, the value of the priority indicator to be inserted into the next data stream transmitted by the software application API_TA, API_JM is updated and becomes the one associated with the new current operating mode.

In relation to [FIG. 4], an embodiment of a method for implementing a data stream received from a software application API_TA, API_JM running on the terminal apparatus UE, IoT in a slice SL_1 of a communication network RC according to one embodiment of the invention is now presented in the form of a flowchart. Advantageously, this data stream STR is received by an execution entity EXE of the user plane UP of the communication network RC and the method is implemented by the device 200 integrated into this execution entity EXE configured to manage at least the network slice SL_1 of the network RC. If the network RC is a 5G compliant mobile communication network, it is for example a device of the radio access network RAN, for example, in an O-RAN architecture, this device may be the one implementing the O-CU-UP (“O-RAN Central Unit-User Plane” [O-RAN]) function, or a device of the network core.

Advantageously, it is assumed here that the execution entity EXE is configured to manage the slices SL_1 and SL_2 of the network RC.

In 40, the data stream STR is received. In 41, a priority indicator IP is detected in the data stream, for example, in a header or in a payload part of this data stream.

In 42, an evaluation of a level of resources NRS_1 available for routing the data stream STR in the network slice SL_1 is obtained. This evaluation can be carried out locally or obtained from a remote device, for example another device of the user plane. The execution entity EXE is aware of the resources available to it and which it can use for each network slice SL it is in charge of. Indeed, in a 5G architecture, when network slices are implemented, the management plane configures each of the access and core network devices according to the characteristics of each slice. These characteristics include notably the bandwidth allocated to each slice.

Each processing rule R_UP then specifies the bandwidth required for the correct operation of each type of data stream likely to be transmitted by the relevant business application API_TA, API_JM.

Finally, the execution entity EXE evaluates whether the resources available for a given slice SL are sufficient to ensure the routing of the received data stream, taking into account the value of the priority indicator IP associated with it. To do this, it compares the quantity of resources required for routing the received stream with the available quantity of resources. It is for example a number of PRBs at a radio access network, or a bit rate in kbits/s or Mbits/s for the network core.

It should be noted that if several data streams are received at the same time, their processing can advantageously be prioritised according to their associated priority level. For example, real-time streams are prioritised over non-real-time streams.

If necessary, a second level of prioritisation can be applied, in the case where several real-time streams use the same network slice and are received at the same time by the execution entity EXE, for example by processing high priority real-time streams before low priority real-time streams. This is particularly the case for a “Voice over IP” application of the operator, which distinguishes priority VoIP data streams and non-priority VoIP data streams. It should be noted that it is possible to do the same for non-real-time streams, by distinguishing between high priority non-real-time streams and lower priority non-real-time streams. In this case, it should be noted that low priority real-time streams with still have priority over non-real-time streams and in particular over high priority non-real-time streams.

In 43, a processing action AC to be executed to process the routing of this data stream is obtained. In 44, the processing action AC is executed.

According to the invention, the processing action AC can be obtained by the execution entity EXE in various ways, which will now be detailed.

According to a first embodiment of the invention, illustrated by [FIG. 4A], at least one rule for processing R_UP the data stream STR received from the software application API_TA, API_JM is obtained in 430. For example, it is assumed that a set of rules has been received from the management entity EGM in a prior configuration phase not shown. Such rules indicate the processing action AC to be executed for the data stream STR. Advantageously, such a processing rule R_UP comprises an identifier of the software application API_TA, API_JN, an identifier of the type of data stream STR_1, an identifier of the network slice SL_1 to be used to transmit the data stream in the communication network RC, the associated priority indicator IP_1 value and an identifier of the action AC to be executed.

For example, the memory in question is organised as a database and the processing rule to be applied to the data stream STR received is obtained by querying the database using the identifier of the software application and/or the identifier of the data stream and the priority indicator detected in the stream.

Advantageously, the processing action AC can take at least one of the following two values:
let the data stream pass (AC1, for example equal to 1) and transfer it to the network slice SL_1;
block (AC2, for example equal to 2) the data stream STR and remove it from the network slice SL_1.

It is understood that the actions AC_1, AC_2 are the two basic actions to be executed in 44. They have the advantage of being simple to implement, based on simple rules, because they are based on binary decision-making. Of course, other actions can be taken into consideration to implement an enriched strategy, when resources are evaluated as insufficient. For example, another possible action would be to speed up or delay the transfer of the data stream STR or assign fewer or more resources to it, or to limit or clip the data stream before transmitting it to adapt to the available resources. In the case where two streams with the same priority are received simultaneously, it would be possible to transfer both by allocating fewer resources to each of them.

In 431, the processing action AC is extracted from the obtained rule R_UP and then applied in 44.

According to this first embodiment, the execution entity EXE has therefore been previously configured to decide locally on the processing action to be executed.

Advantageously, it may have previously received a first processing rule R_UP0 indicating whether it should decide locally on the processing action to be executed or whether it should notify another entity of the communication network RC.

As a variant, it can simply check in memory whether it has a rule R_UP for the software application from which the received data stream originates and for the detected priority indicator IP. If no corresponding rule R_UP is found, then it notifies another entity or it applies a default rule R_UP_D which defines the processing action to be executed for a data stream originating from the relevant software application or from all customers' software applications of the network slice SL_1, associated with the lowest priority level IP_3.

According to a second embodiment of the invention illustrated by [FIG. 4B], it is considered that the execution entity EXE is configured to notify another entity of the communication network RC. Advantageously, it is a control entity CTR of the control plane of the network RC, configured to control the implementation of a policy for processing the data streams routed in said network RC. For example, the first rule R_UP0 identifies this control entity CTR to be notified and the information to be transmitted to it.

In 430′ (of [FIG. 4B]), the execution entity obtains this first rule R_UP0 and thus extracts the identity of the control entity to be notified.

In 431′, it notifies the control entity CTR that it has received the data stream STR associated with the priority indicator IP in the network slice SL_1. It should be noted that it can trigger this notification following detection of the priority indicator IP in the data stream STR, that is systematically notify the control entity CTR in a message comprising a single priority indicator associated with a single received data stream, or, as a variant, transmit a single notification message NTF after a given time period grouping the priority indicators detected in data streams received on the network slice SL_1 during this period.

In 432′, it receives in return the processing action to be executed. It is for example one of the two actions AC_1, AC_2 discussed above or, according to the enriched strategy, another action, for example delaying or accelerating the transfer of the data stream STR or limiting or clipping the data stream before transfer. In 44, it executes the received processing action.

According to this second embodiment of the invention, the control plane applies the data stream processing rules according to the priority indicators associated with these streams.

In relation to [FIG. 5], an embodiment of a method for controlling a data stream received from a software application API_TA, API_JN in a data slice SL1 of the communication network according to this second embodiment is now presented in the form of a flowchart. Advantageously, the method is implemented by the device 300 integrated into the control entity CTR of the control plane of the communication network RC.

In 50, a notification NTF is received by the control entity CTR from the execution entity EXE of the user plan of the communication network RC. It relates to a data stream STR received by this execution entity EXE and comprises at least an identifier of the type of data stream STR_1, an associated priority indicator IP_1 and the identifier of the network slice SL_1. For example, this notification is transmitted to the control entity in a message that complies with a protocol such as radius, diameter or http/2. In the case of a Service-Based Architecture (SBA) for 5G, the http/2 protocol is used.

In 51, the control entity CTR obtains an evaluation of a level of resources available in the network slice SL_1. With respect to the resources requirements for transmitting the received data stream STR under the conditions provided for the priority level associated with it, the mechanisms implemented are similar to those described for step 42 and will not be detailed further.

In the access network of a 5G architecture implementing an O-RAN implementation, the control entity or function CTR retrieves the information relating to available resources for each network slice from the O-CU-CP function.

In the core network, the control entity or function CTR retrieves this available resource information from a Session Management Function (SMF) which controls the User Plane Function (UPF) corresponding to the execution entity or function EXE in question, via the N4 interface as defined by 3GPP in the TS23.501 specification (section 5.8.2.11 “Parameters for N4 session management”).

In 52, it obtains a rule for controlling R_CP the data streams routed on the network slice SL_1 and associated with the received priority indicator IP. Advantageously, it is assumed that a set of rules R_CP has been received from the management entity EMG in a prior configuration phase not shown. Such rules indicate the processing action AC to be executed for the data stream STR according to the value of its associated priority indicator. Advantageously, such a control rule R_CP comprises an identifier of the network slice SL_1, the value of the priority indicator IP_1 and an identifier of the action AC to be executed.

It is understood that this control rule R_CP is very similar in its structure and content to a processing rule R_UP. One difference is that the control rules R_CP can be more complex because the control entity or function CTR generally has a broader view of the domain for which it is responsible than the execution entity or function EXE, which only is aware of its own resources and therefore has a scope of action limited to its function.

For example, the memory in question is organised as a database and the control rule R_CP to be applied to the received notification NTF is obtained by querying the database using the identifier of the data slice SL_1 and the priority indicator IP received in the notification.

In 53, the processing action AC is extracted from the received rule, then in 54 a response is transmitted to the execution entity in a message comprising at least the processing action AC. For example, this message is compliant with the JSON format and is sent using the http/2 protocol.

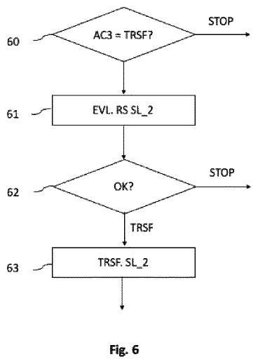

In relation to [FIG. 6], another embodiment of the invention, implemented when the processing action decided for the data stream STR is to block this stream in the network slice SL_1, is now presented in the form of a flowchart. In particular, a mechanism is described below which can be implemented either at the execution entity EXE as part of the method for processing a data stream just described in relation to [FIG. 4], or at the control entity CTR as part of the method for controlling a data stream just described in relation to [FIG. 5].

The mechanism in question is therefore triggered following the obtaining 43 of the action AC at the execution entity EXE when this action is an action AC2 to block the data stream in the network slice SL_1 or, more generally, when the available resources are evaluated as insufficient and an action to limit the stream or delay the transfer of the stream has been taken, or following the decision 53 to execute this action AC at the control entity CTR. In 60, it is checked whether there is another processing R_UP_FK or control R_CP_FK rule for a data stream of the software application API_TA, API_JM, associated with the priority indicator IP in the network slice SL_1, which provides for a third processing action AC_3 consisting in transferring the blocked data stream to another network slice SL_2 accessible to the customer of the relevant software application. For example, this additional rule, referred to as the fallback rule, is obtained by querying the local memory database, as described above.

It is first assumed that this fallback rule is not available. In this case, the processing action to be executed remains the action AC2 to block, therefore remove, the data stream of the network slice SL_1 or to limit the stream depending on the resources available for routing.

When, on the other hand, this fallback rule is available for the current data stream, then the availability of the resources in another network slice accessible to the customer of the software application, in this case the slice SL_2, is evaluated in 61. A quantity of available resources is obtained and then compared with a given minimum threshold TH or the resource requirements for routing the data stream STR in 62. If this other network slice SL_2 has sufficient resources and/or more available resources than the network slice SL_1 for routing the data stream STR, that is if the quantity of resources evaluated is greater than or equal to the threshold TH, then the data stream STR is transferred to the other network slice SL_2.

Advantageously, such a fallback rule R_UP_FK, R_CP_FK is associated with the priority indicators corresponding to high priority levels. For example, for the software application API_TA, AP_JN, only data streams associated with a priority indicator IP_1 can benefit from this fallback solution to another network slice SL_2. When operating modes are implemented, it should be noted that these are the only data streams of type STR_1 in nominal mode MO_1 that can benefit from the fallback solution, but that all the data streams of type STR_1, STR_2 and STR_3 in alarm mode MO2 can benefit from it.

This mechanism therefore has the advantage of offering an additional chance for a priority data stream to be routed when the resources of the user plane UP are not sufficient in the network slice SL_1 selected for the application that transmitted it.

It is articulated as follows with the two previously described embodiments:
in the case of the first embodiment, according to which the execution entity EXE decides locally on the action to be executed by applying processing rules obtained beforehand from the management entity EMG, the fallback mechanism just described can either also be executed locally based on a fallback rule R_UP_FK provided that the execution entity is in charge of managing at least two network slices SL_1, SL_2 accessible to the software application concerned, or the decision to block the data stream STR or to limit the data stream STR triggers the transmission of a notification to the control entity CTR so that it implements the fallback mechanism in question. For example, the notification comprises the priority indicator, the identifier of the software application API_TA, API_JN, the identifier of the selected network slice SL_1. Upon receipt, the control entity CTR implements the fallback mechanism and responds to the notification by transmitting either a confirmation of the blocking action (or routing limitation) AC_2 or the transfer action AC_3, specifying the network slice SL_2 to which the data stream is to be transferred;
in the case of the second embodiment, according to which the execution entity EXE notifies the control entity CTR on which it depends of the priority indicator detected in the data stream STR it has received, and the network slice SL_1 in which it has received it, the fallback mechanism is advantageously implemented by the control entity CTR following the decision 52 to have the entity EXE execute the decision AC_2 to block the data stream STR. In this way, the control entity only sends the transfer action AC_3 in its response to the notification NTF from the execution entity EXE, associated with the network slice SL_2 to which this transfer is to be performed.

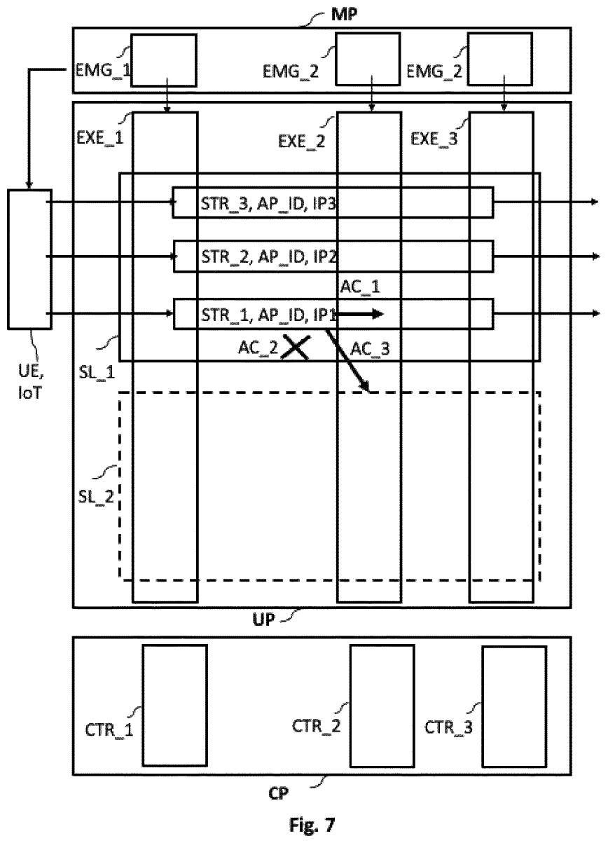

In relation to [FIG. 7], an example of the architecture of a communication network RC implementing the invention is now presented. It comprises a management plane MP, a user plane UP and a control plane CP. The management plane MP comprises a plurality of management entities EMG_1, EMG_2, EMG_3 configured to define rules for routing, processing and controlling data streams in the various slices SL_1, SL_2 of the network RC. In particular, the management entities are configured to transmit data stream routing rules to terminal apparatuses UE, IoT connected to the network RC, processing rules to a plurality of execution entities EXE_1, EXE_2, EXE_3 of the user plane UP, and control rules to a plurality of control entities CTR_1, CTR_2, CTR_3 of the control plane CP of the network RC.

These rules make it possible to decide, according to a level of resources available in a network slice and a priority level of this stream, whether a data stream can be routed or should be blocked.

Some of these execution entities can be configured to manage several slices SL_1, SL_2 of the network RC, others only one. Those configured to manage at least two slices of the network RC will be able to implement the fallback mechanism described in relation to [FIG. 6] and apply it to the highest priority data streams.

As previously described, this fallback mechanism can, as a variant, be implemented by control entities CTR_1, CTR_2, CTR_3 when the execution entities they control manage at least two network slices. For example, the execution entity EXE_1 detects an “alarm” operating mode and informs the control entity CTR_1 that manages the entity EXE_1. This entity CTR_1 can then decide to duplicate the streams to another network slice SL_2 which is controlled by an execution entity EXE_1′ (not shown) for the user plane and by the same entity CTR_1 for the control plane.

The execution entities of the user plane are placed along the path or route taken by a data stream STR transmitted by the terminal apparatus UE, IoT to its destination. It is therefore understood that each of them is configured to implement the method for processing a data stream just described under the control of the control entity CTR_1, CTR_2, CTR_3 on which it depends.

It should be noted that the invention also applies in a multi-operator context and that, as a result, some execution or control entities may be configured to be aware of the resources of a network slice of another operator and to take a decision to transfer a data stream to this network slice. For example, the control entity that makes the decision about routing the data stream may receive information relating to a level of resources available in that network slice of another operator from a control entity managed by that other operator.

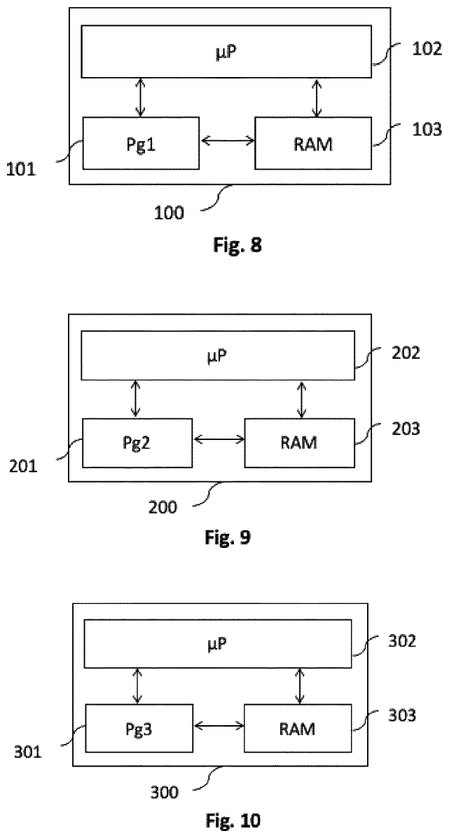

In relation to [FIG. 8], an example of a hardware structure of a device 100 for transmitting a data stream in a telecommunication network is now presented, to which a terminal apparatus is connected, said network being divided into a plurality of network slices, said device comprising a module for selecting one network slice from said plurality at least according to the identifier of the software application, a module for obtaining a type of said stream, said type belonging to a group comprising at least one first type and a second type of stream, a module for inserting a priority indicator associated with the type of stream into a header of the data stream, the priority indicator belonging to a group comprising at least one first indicator associated with the first type of stream and a second indicator associated with the second type of stream, the first priority indicator and the second priority indicator having different values, and a module for transmitting the data stream in the selected network slice.

Advantageously, the device 100 comprises a module or receiving at least one rule for routing a data stream for said software application, said rule comprising at least an identifier of said software application, said type of stream, said priority indicator associated with said type of stream and an identifier of a said network slice, a module for storing in memory said at least one processing routing, the selection and insertion modules being configured to apply said at least one rule. Advantageously, the device 100 also comprises a module for obtaining an operating mode of said software application, said operating mode belonging to a group comprising at least one first operating mode and a second operating mode, said at least one routing rule being associated with said operating mode.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (for example, a RAM memory), a processing unit 102 equipped for example with a processor and controlled by a computer program Pg1, representative of the selection, obtaining, insertion, reception and storing modules, stored in a read-only memory 101 (for example, a ROM memory or hard disk). At initialisation, the code instructions of the computer program are for example loaded into a random access memory 103 before being executed by the processor of the processing unit 102. The random access memory 103 may also contain, for example, the obtained identifier of the software application, type of data stream and operating mode.

FIG. 8 only illustrates a particular one of several possible ways of realising the device 100, so that it executes the steps of the method for transmitting a data stream as detailed above, in relation to [FIG. 3] in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to a device 100 integrated into a terminal apparatus connected to a communication network RC, but it can also be integrated into a device for accessing this network, for example a connectivity gateway integrating this device 100. Such a connectivity gateway usually serves as an interface between light IoT modules (that is with low onboard processing capacity) and the communication network RC. It is for example implemented for energy management. IoT sensors feed back measurement data about users' energy consumption to a connectivity gateway, which is typically configured to aggregate about ten IoT sensors.

In relation to [FIG. 9], an example of a hardware structure of a device 200 for processing a data stream received in a telecommunication network is then presented, said network being divided into a plurality of network slices, said data stream having been received from a software application running on a terminal apparatus connected to said network in a said network slice of said plurality, said device comprising a module for obtaining an evaluation of a level of resources available in the network slice, a module for detecting a priority indicator in a header of said data stream, and a module for executing at least one action for processing said data stream according to at least said priority indicator and the level of network resources available in said network slice, said processing action belonging to a group comprising at least one first action to let the data stream pass in said network slice, when the level of available resources is sufficient, and a second action to block the data stream in said network slice, intended to be implemented when the level of available network resources is insufficient.

Advantageously, the device 200 comprises a module for previously obtaining at least one rule for processing a data stream received from said software application, said rule comprising said priority indicator of a data stream, said network slice identifier and said at least one action for processing said stream, and an extraction module (for extracting the processing action from said rule). Advantageously, said device also comprises a module for notifying said priority indicator to a control entity of said network, configured to be implemented when no processing rule has previously been obtained for processing said data stream, and a module for receiving, from said control entity, said at least one processing action to be executed. Advantageously, the device 200 finally comprises a module for obtaining an evaluation of a level of resources in another network slice and a module for deciding on at least one third processing action, referred to as the action for transferring the data stream, according to said level of resources (and the priority indicator, as a replacement for the second processing action). These modules are configured to be implemented when the execution entity is configured to manage the network slice and said at least one other network slice of said communication network and when the processing action is the second action to block the data stream in the network slice.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a random access memory 203 (for example, a RAM memory), a processing unit 202 equipped for example with a processor and controlled by a computer program Pg2, representative of the above-mentioned modules, stored in a read-only memory 201 (for example, a ROM memory or hard disk). At initialisation, the code instructions of the computer program are for example loaded into a random access memory 203 before being executed by the processor of the processing unit 202. The random access memory 203 may also contain, for example, the obtained identifier of the software application, priority indicator, network slice, level of resources evaluated for the network slice, and type of data stream. It may also comprise the previously received processing rules, the resource level(s) evaluated for the network slice(s), the decision threshold(s) implemented to decide whether the evaluated resource level(s) is/are sufficient for routing the data stream.

FIG. 9 only illustrates a particular one of several possible ways of realising the device 200, so that it executes the steps of the method for controlling the processing of a data stream as detailed above, in relation to FIGS. 4, 4A, 4B and 6, in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to a device 200 integrated into an execution entity of the communication network RC, for example a node device of the access network, for example a base station of a mobile radio access network or a router device of the core network.

Finally, in relation to [FIG. 10], an example of a hardware structure of a device 300 for controlling the processing of a data stream received in a telecommunication network is presented, said network being divided into a plurality of network slices, said data stream having been transmitted by a terminal apparatus and received by an execution entity of said network in a network slice of said plurality, said device comprising a module for receiving from the execution entity a notification of a priority indicator (IP) associated with said received data stream, a module for obtaining a level of resources available in the network slice, a module for deciding on at least one action for processing said stream at least according to the received priority indicator and the level of available resources, and a module for sending a response to said execution entity, said response comprising said processing action.

Advantageously, the device 300 comprises a module for previously obtaining at least one rule for controlling the processing of a data stream received from said software application, said rule comprising said priority indicator of a data stream, said network slice identifier and said at least one action for processing said stream, and a module for storing said at least one rule in memory. Advantageously, said device 300 also comprises a module for obtaining a level of resources available in another network slice, a module for deciding on at least one third processing action, referred to as the action for transferring the data stream, according to said level of resources and the priority indicator, as a replacement for the second processing action. These modules are configured to be implemented prior to transmitting the second processing action to the execution entity, when the decided processing action is the action to block said data stream in the network slice and when the execution entity is configured to manage another network slice of said plurality.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 300 comprises a random access memory 303 (for example, a RAM memory), a processing unit 302 equipped for example with a processor and controlled by a computer program Pg3, representative of the above-mentioned modules, stored in a read-only memory 301 (for example, a ROM memory or hard disk). At initialisation, the code instructions of the computer program are for example loaded into a random access memory 303 before being executed by the processor of the processing unit 302. The random access memory 303 may also contain, for example, the previously received control rules, the obtained identifier of the software application, priority indicator, network slice, level of resources evaluated for the network slice, type of data stream. It may also comprise the level of resources evaluated for the other network slice, the decision threshold(s) implemented to decide whether the evaluated resource level(s) is/are sufficient for routing the data stream.

FIG. 10 only illustrates a particular one of several possible ways of realising the device 300, so that it executes the steps of the method for controlling the processing of a data stream as detailed above, in relation to FIGS. 5 and 6, in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 300 is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to a device 300 integrated into a control entity of the communication network RC, for example a device for controlling the access network or a device for controlling the core network. For example, this device 300 is implemented in an O-CU-CP functional entity of a mobile access network according to the O-RAN specifications. Concerning the mobile core network, this device 300 may be implemented in a functional entity SMF in accordance with the 3GPP specifications of the 5G architecture.

1. A method for transmitting a data stream received from a software application running on a terminal apparatus, in a communication network to which said terminal apparatus is connected, said network being divided into a plurality of network slices, wherein said method is implemented at said terminal apparatus and comprises:
selecting a network slice from said plurality at least according to an item of information comprised in a header of the data stream;
obtaining a type of said stream, said type belonging to a group comprising at least one first type and a second type of stream;
inserting a priority indicator associated with the type of stream into the data stream, the priority indicator belonging to a group comprising at least one first indicator associated with the first type of stream and a second indicator associated with the second type of stream, the first priority indicator and the second priority indicator having different values; and
transmitting the data stream comprising the priority indicator in the selected network slice.

2. The method for transmitting a data stream according to claim 1, wherein the method comprises:
previously receiving at least one rule for routing a data stream transmitted by said software application, said rule comprising at least an identifier of said software application, said type of stream, said priority indicator associated with said type of stream and an identifier of a said network slice;
storing in memory said at least one routing rule; and
applying said at least one routing rule when implementing said selection and said insertion.

3. The method for transmitting a data stream according to claim 2, wherein the method further comprises obtaining an operating mode of said software application, said operating mode belonging to a group comprising at least one first operating mode and a second operating mode, and wherein said at least one routing rule is associated with said operating mode.

4. A method for processing a data stream in a communication network, said network being divided into a plurality of network slices, said data stream having been received in a said network slice of said plurality from a software application running on a terminal apparatus connected to said network, wherein the method is implemented by an execution entity of the network and that it comprises:
detecting a priority indicator of said stream in said data stream;
evaluating a level of resources available in the network slice;
executing at least one action for processing said data stream at least according to said priority indicator and the level of network resources available in said network slice, said processing action belonging to a group comprising at least one first action to let the data stream pass in said network slice, when the level of available resources is sufficient for routing the data stream according to the priority indicator, and a second action to block the data stream in said network slice, intended to be implemented when the level of available network resources is insufficient.

5. The method for processing a data stream according to claim 4, wherein the method comprises previously obtaining at least one rule for processing a data stream received from said software application, said rule comprising said priority indicator of a data stream, said network slice identifier and said at least one action for processing said stream, and extracting the processing action from said rule.

6. The method for processing a data stream according to claim 4, wherein said method further comprises, when no processing rule has been previously obtained for processing said data stream, notifying said priority indicator to a control entity of said network and receiving, from said control entity, said at least one processing action to be executed.

7. The method for processing a data stream according to claim 4, wherein, the execution entity being configured to manage the network slice and at least one other network slice of said communication network, the method comprises, in response to the processing action being the second action to block the data stream in the network slice, prior to executing the second processing action:
evaluating a level of resources in the other network slice;
deciding on at least one third processing action, referred to as an action to transfer the data stream to the other network slice, according to said level of resources and the priority indicator.

8. A method for controlling processing of a data stream in a communication network, said communication network being divided into a plurality of network slices, said data stream having been transmitted by a terminal apparatus and received by an execution entity of said network in a network slice of said plurality, wherein said method is implemented by a control entity of said network, said control entity being configured to control implementation of a policy for processing the data streams routed in said network, and wherein said method comprises:
receiving from the execution entity a notification of a priority indicator associated with said received data stream;
obtaining a level of resources available in the network slice;
deciding on at least one action for processing said stream at least according to the received priority indicator and the level of available resources, said processing action belonging to a group comprising at least one first action to let the data stream pass in said network slice intended to be implemented when the level of available network resources is sufficient for routing the data stream according to the priority indicator and a second action to block the data stream in said network slice intended to be implemented when the level of available network resources is insufficient; and
sending a response to said execution entity, said response comprising said processing action.

9. The method for controlling a data stream according to the claim 8, wherein the method comprises, in response to the processing action decided upon being the action to block said data stream in the network slice and the execution entity being configured to manage another network slice of said plurality, prior to transmitting the second processing action to the execution entity:
obtaining a level of resources available in the other network slice;
deciding on at least one third processing action, referred to as the action to transfer the data stream to the other network slice, according to said level of resources and the priority indicator.

10. A device for transmitting a data stream by a software application running on a terminal apparatus, in a communication network to which said terminal is connected, said network being divided into a plurality of network slices, wherein said device comprises:
at least one processor; and
at least one non-transitory computer readable medium comprising instructions stored thereon which when executed by the at least one processor configure the device to implement at the terminal apparatus:
selecting a network slice from said plurality at least according to an item of information comprised in a header of the data stream;
obtaining a type of said stream, said type belonging to a group comprising at least one first type and a second type of stream;
inserting a priority indicator associated with the type of stream into the data stream, the priority indicator belonging to a group comprising at least one first indicator associated with the first type of stream and a second indicator associated with the second type of stream, the first priority indicator and the second priority indicator having different values; and
transmitting the data stream comprising the priority indicator in the selected network slice.

11. A device for processing a data stream in a communication network, said network being divided into a plurality of network slices, said data stream having been received in a said network slice of said plurality, from a software application running on a terminal apparatus connected to said network, wherein the device comprises:
at least one processor; and
at least one non-transitory computer readable medium comprising instructions stored thereon which when executed by the at least one processor configure the device to implement at an execution entity of the network:
detecting a priority indicator of said stream in said data stream;
evaluating a level of resources available in the network slice;
executing at least one action for processing said data stream at least according to said priority indicator and the level of network resources available in said network slice, said processing action belonging to a group comprising at least one first action to let the data stream pass in said network slice, when the level of available resources is sufficient, and a second action to block the data stream in said network slice, intended to be implemented when the level of available network resources is insufficient.

12. A device for controlling the processing of a data stream in a communication network, said communication network being divided into a plurality of network slices, said data stream having been transmitted by a terminal apparatus and received by an execution entity of said network in a network slice of said plurality, wherein said device comprises:
at least one processor; and
at least one non-transitory computer readable medium comprising instructions stored thereon which when executed by the at least one processor configure the device is configured to implement at a control entity of said network, said control entity being configured to control the implementation of a policy for processing the data streams routed in said network:
receiving from the execution entity a notification of a priority indicator associated with said received data stream;
obtaining a level of resources available in the network slice;
deciding on at least one action for processing said stream at least according to the received priority indicator and the level of available resources, said processing action belonging to a group comprising at least one first action to let the data stream pass in said network slice intended to be implemented when the level of available network resources is sufficient and a second action to block the data stream in said network slice intended to be implemented when the level of available network resources is insufficient; and
sending a response to said execution entity, said response comprising said processing action.

13. A terminal connectable to a communication network, said network being divided into a plurality of network slices, wherein the terminal comprises a device for transmitting a data stream in a network slice of said plurality by a software application running on the terminal, wherein said device comprises:
at least one processor; and
at least one non-transitory computer readable medium comprising instructions stored thereon which when executed by the at least one processor configure the device to:
select a network slice from said plurality at least according to an item of information comprised in a header of the data stream;
obtain a type of said stream, said type belonging to a group comprising at least one first type and a second type of stream;
insert a priority indicator associated with the type of stream into the data stream, the priority indicator belonging to a group comprising at least one first indicator associated with the first type of stream and a second indicator associated with the second type of stream, the first priority indicator and the second priority indicator having different values; and
transmit the data stream comprising the priority indicator in the selected network slice.

14. (canceled)

15. A non-transitory computer readable medium comprising program code instructions stored thereon for implementing a method for transmitting a data stream received from a software application running on a terminal apparatus, in a communication network to which said terminal apparatus is connected, when the instructions are executed by a processor, said network being divided into a plurality of network slices, and said method being implemented at said terminal apparatus and comprising:
selecting a network slice from said plurality at least according to an item of information comprised in a header of the data stream;
obtaining a type of said stream, said type belonging to a group comprising at least one first type and a second type of stream;
inserting a priority indicator associated with the type of stream into the data stream, the priority indicator belonging to a group comprising at least one first indicator associated with the first type of stream and a second indicator associated with the second type of stream, the first priority indicator and the second priority indicator having different values; and
transmitting the data stream comprising the priority indicator in the selected network slice.
